(19) United States
(12) Patent Application Publication
(10) Pub. No.: US 2008/0309507 A1
(43) Pub. Date: Dec. 18, 2008

(54) SELF-CONFIGURING DATA ACQUISITION SYSTEM FOR DIAGNOSTIC TESTING

(76) Inventors: Paul Gene Anderson, Acworth, GA (US); Tony John Morris, Kennesaw, GA (US); Christopher Paul Smith, Woodstock, GA (US); David Quinn Heagerty, Glenn Mills, PA (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/764,812

(22) Filed: Jun. 19, 2007

Related U.S. Application Data
(60) Provisional application No. 60/943,342, filed on Jun. 12, 2007.

(51) Int. Cl. G08B 21/00

(52) U.S. Cl. 340/679

(57) ABSTRACT

A self-configuring data acquisition system and method for conducting diagnostic testing of process equipment devices. The data acquisition system includes a data acquisition processing unit for controlling diagnostic testing of an equipment device, the equipment device including a digital information unit that stores information uniquely identifying the equipment device. A signal conditioning unit is coupled to the data acquisition unit by a first data transmission means, the signal conditioning unit including a digital information unit that stores information uniquely identifying the signal conditioning unit. A sensor is coupled with the equipment device under test, wherein the sensor is further coupled to the signal conditioning unit by a second data transmission means, and wherein the sensor includes a digital information unit that stores information uniquely identifying the sensor. Each digital information unit transmits its stored identifying information to the data acquisition processing unit. A component automatically configures the signal conditioning unit, based on the sensor and equipment device identifying information, to excite the equipment device under test and receive a plurality of test data input signals from the equipment device resulting from the excitation.

### BACKGROUND OF THE INVENTION

The present invention is related generally to data acquisition systems for diagnostic system and, more particularly, to self-configuring data acquisition systems for diagnostic systems.

Portable data acquisition systems are used in the nuclear power industry to measure the performance characteristics of power-operated valves and motors. Various commercially available sensors, such as motor current probes and pressure transmitters, and valve-specific sensors, such as strain gage instruments and displacement measuring tools, are used simultaneously on a valve to determine the condition of the valve and its performance. Depending upon the equipment that is being monitored, various sensors and signal conditioning channels will be used.

An example of a commercially available portable data acquisition system is the VIPER™ 20 modular system available from Crane Nuclear, Inc. Features of the VIPER 20 include 16 user-definable data channels plus four system-specific channels. There are four module (card) slots that can be changed out depending upon the type of sensors that are needed for the test, since different circuitry is required to provide the correct excitation voltage for different sensors and to process the input signals from these different devices. FIG. 1 illustrates the VIPER 20 portable data acquisition system.

The user must plug the sensor into the correct card and then manually input the sensor type, serial number, sensitivity (i.e., conversion factor to translate a signal to proper engineering units), calibration due date, units of measure (i.e., pounds, amperes, inches, etc.) into the transducer database of the software. In the software, the user then must associate the channel used with the sensor in the transducer database.

Once each sensor is manually selected and assigned, the user must also select the equipment to be monitored from the valve database in the software. If the equipment is not listed in the valve database, the user must create the entry and input pertinent information about it. The user then connects the sensors to the valve and operates the valve. As the valve operates, data from all sensors is acquired. Once data acquisition is complete, the analog signals are converted to digital signals and sent to a notebook computer over an Ethernet link. In the software, the raw data is stored along with a conversion factor. The user can then analyze the data, print graphs, mark events, print reports, etc.

Although current portable diagnostic systems, such as the Viper 20, are accurate and dependable, they are also bulky and cumbersome (approximately 16 pounds) to use. The standard sensor cable types vary depending on the type of sensor and are typically 35 feet long. Multiple keystrokes are required within the software user interface to navigate from data acquisition to analysis.

There is a need for a system that reduces the time it takes to perform and analyze tests, improves accuracy, minimizes maintenance, provides a simplified software user interface, and includes a more portable system. Such a system should provide automatic identification of components, include both a wired and a wireless capability, and provide a battery-powered option.

### SUMMARY OF THE INVENTION

Exemplary embodiments of the self-configuring data acquisition system include sensors, signal conditioning modules, data transmission means, a central system and data recording means and is used to periodically test process equipment to verify correct configuration and operability and to facilitate necessary adjustments. Automatic identification of the equipment under test, sensors, and signal conditioning modules is provided by digital information units that are installed in, or affixed to, equipment devices, sensors, and signal conditioning units, and transmit the associated identifying information to a data acquisition processing unit.

In one aspect of the invention, a self-configuring data acquisition system is provided for conducting diagnostic testing of process equipment devices. The data acquisition system includes a data acquisition processing unit for controlling diagnostic testing of an equipment device, the equipment device including a digital information unit that stores information uniquely identifying the equipment device and automatically transmits the identifying information to the data acquisition unit. A signal conditioning unit is coupled to the data acquisition unit by a first data transmission means, the signal conditioning unit including a digital information unit that stores information uniquely identifying the signal conditioning unit and automatically transmits the identifying information to the data acquisition unit. A sensor is associated with the equipment device under test, wherein the sensor is coupled to the signal conditioning unit by a second data transmission means, the sensor including a digital information unit that stores information uniquely identifying the sensor and automatically transmits the identifying information to the data acquisition unit. A component receives the identifying information from the sensor and equipment device digital information units and automatically configures the signal conditioning unit, based on the sensor and equipment device identifying information, to excite the equipment device under test and receive a plurality of test data input signals from the equipment device resulting from the excitation.

In another aspect of the invention, a method is provided for automatically conducting diagnostic testing of process equipment devices in a data acquisition system. The method includes the steps of: providing a digital information unit for each of a plurality of components of the data acquisition system including an equipment device under test, a signal conditioning unit, and a sensor associated with an equipment device under test, each digital information unit including information that uniquely identifies a corresponding component; automatically transmitting the identifying information stored on each digital information unit to a data acquisition processing unit; automatically configuring the signal conditioning unit, based on the sensor and equipment device identifying information, to excite the equipment device under test; and receiving a plurality of test data input signals from the equipment device resulting from the excitation by the signal conditioning unit.

### BRIEF DESCRIPTION OF THE DRAWINGS

These and other advantages and aspects of the present invention will become apparent and more readily appreciated from the following detailed description of the invention taken in conjunction with the accompanying drawings, as follows.

FIG. 1 illustrates a prior art portable data acquisition system used in the nuclear power industry.

FIG. 2 illustrates a system architecture of the self-configuring data acquisition system in accordance with an embodiment of the invention.

FIG. 3 illustrates a data processing architecture of the self-configuring data acquisition system in accordance with an embodiment of the invention.

FIGS. 4-6 illustrate a series of user interfaces for the data acquisition wizard in accordance with an embodiment of the invention.

FIG. 7 illustrates an exemplary circuit diagram for a digital information identification unit.

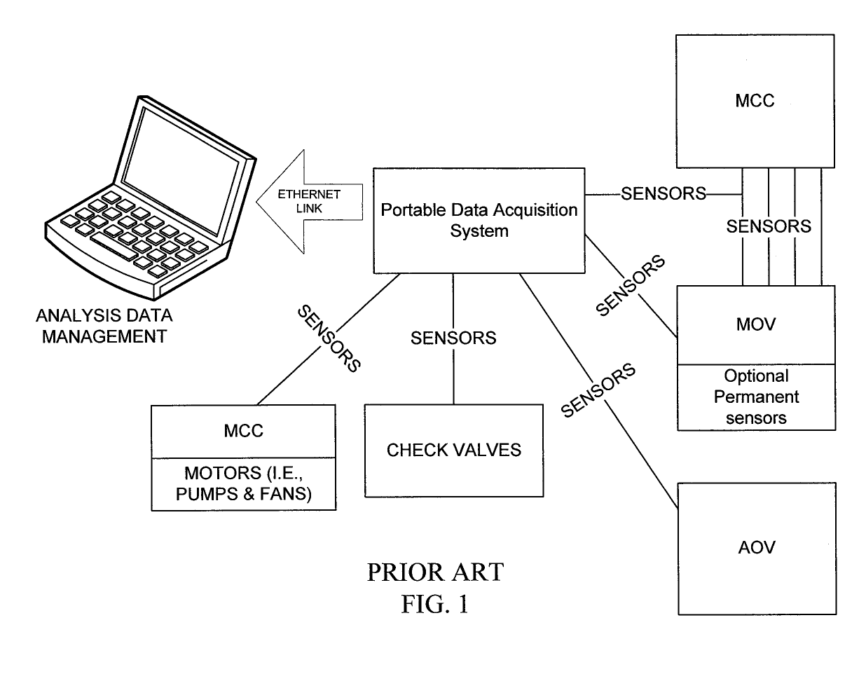

### DETAILED DESCRIPTION OF THE INVENTION

The following description of the invention is provided as an enabling teaching of the invention and its best, currently known embodiment. Those skilled in the relevant art will recognize that many changes can be made to the embodiments described, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and may even be desirable in certain circumstances, and are a part of the present invention. Thus, the following description is provided as illustrative of the principles of the present invention and not in limitation thereof, since the scope of the present invention is defined by the claims.

In an exemplary embodiment, the self-configuring data acquisition system includes sensors, signal conditioning modules, data transmission means, a central system and data recording means and is used to periodically test process equipment to verify correct configuration and operability and to facilitate necessary adjustments.

Embodiments of the portable diagnostic system for use in the nuclear power industry can acquire and analyze data on air-operated valves (AOV), motor-operated valves (MOV), and check valves. The portable diagnostic system is designed as a rugged, portable acquisition system that provides a step-change improvement in technology when compared to prior art systems. As a result of recent technology advances, embodiments of the portable diagnostic system provide a reduction in complexity making the system easier to transport, use and maintain and allowing increased accuracy.

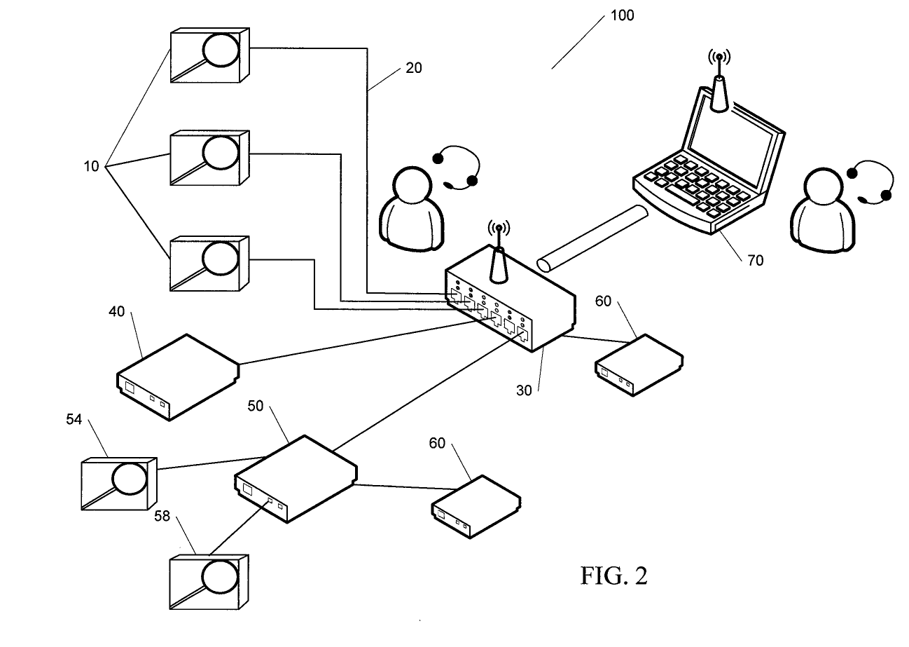

FIG. 2 illustrates an exemplary system architecture. The exemplary portable diagnostic system 100 includes the following assemblies: sensors 10, sensor cables 20, data acquisition unit (DAU) 30, contacts cable assembly (CCA) 40, eddy current signal conditioning assembly (ECSCA) 50, AC power supplies 60 for the DAU 30 and ECSCA 50, and a portable computer (PC) 70. The system can support 12 universal connectors. Additional features include a built-in wireless capability, an eight-hour capacity battery for the DAU 30, automatic identification of sensors and valves, interchangeable cables, a voice communication option and the ability to run the software on an ultra-mobile PC 70. The communications interfaces of the portable diagnostic system 100 comply with both the Ethernet 100BaseT wired and IEEE 801.11g wireless standards by using commercially available modular technology.

The contacts cable assembly 40 internal circuitry detects impedance change across a switch. If the detected current is above a threshold value, the switch is considered closed. Otherwise, the switch is considered open. The CCA assembly 40 can monitor six switches: three open and three closed (i.e., torque, bypass, limit). The CCA assembly 40 multiplexes individual digital detections into an analog signal. The CCA assembly 40 output analog signal varies based on an open or closed condition of each input switch.

The eddy current signal conditioning assembly 50 includes two eddy current sensors that are used to measure the position of a disk in a check valve with electromagnetic principles. The ECSCA 50 excites the sensors and performs signal conditioning of the amplified return for a two-valve configuration into the DAU 30.

The power supplies 60 provide an alternating current voltage operating range from 85 VAC to 260 VAC at 50/60 Hz. The power supplies 60 utilize automatic switching for varying voltage inputs. The same power supply can be used for both DAU 30 and ECSCA 50.

The PC 70 that communicates with DAU 30 should have the following minimum characteristics: minimum of 512 megabytes of RAM, minimum of 30 gigabytes of hard disk storage, an internal battery, Ethernet 100baseT and IEEE 802.11 g wireless capability, minimum screen resolution of 800×400 pixels, USB 2.0 compliant expansion and microphone, headset, mouse, and keyboard interfaces. The Ethernet 100BaseT capability is provided by an installed Ethernet adapter and an RJ-45 connector. The IEEE 802.11 g wireless capability is provided by an installed wireless adapter.

In exemplary embodiments, the DAU 30 processor should have the capabilities identified herein. The DAU 30 processor (32 bit) should be able to initialize all hardware, save configuration and identification information, and communicate between the sensors 10 and the PC 70. The DAU 30 processor should have the ability to distinguish between a wired or wireless Ethernet connection. The DAU 30 processor should be capable of loading a complete operating system (OS) image and incorporating a real time clock for data synchronization with multiple DAUs. The DAU 30 processor should also include a built-in low-powered, high efficiency switcher supply. The DAU 30 software should be upgradeable remotely over the network. The DAU 30 processor should use multiple clock modes for various operation conditions with clock rates that are adjustable based on current processor requirements. The DAU 30 processor should have adequate flash memory for boot loader, OS and application program storage. The DAU 30 processor should have adequate random access memory (RAM) for the application program and at least 64 Mbytes for data retention. The DAU 30 processor should be capable of saving all configuration data during power interruption. Voice over IP (VoIP) functionality could be accessible to the analysis PC 70 through hardware and software.

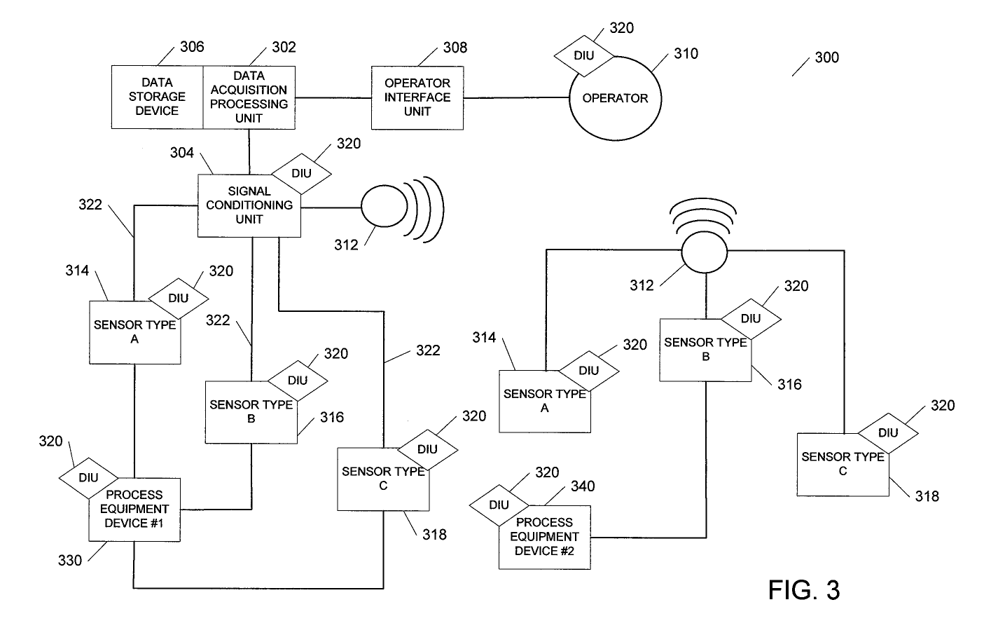

FIG. 3 illustrates a data processing architecture 300 of the self-configuring data acquisition system in an embodiment of the invention. A digital information unit (DIU) 320 in each element of the data acquisition system 300 provides individual identification of the element and other configuring information to a central recording function of the system. These digital information units 320 are installed in each sensor 314, 316, 318, signal conditioning module 304, data transmission component 312 (wireless), 322 (wired), and peripheral device 302, 306, 308 of the system. Each component of process equipment 330, 340 to be tested is also equipped with a digital information unit 320. Potentially, each person 310 operating the data acquisition system 300 could use a digital information unit 320 to identify themselves as the operator of a given test or sequence. The intent is that, at the time of each test, the operator 310 would be required to enter little or no information. Ideally, the system 300 would be connected and would self-configure, and the relevant type of test that would be triggered and stored with no required user interaction. Some selection options might be desired, but these could be reduced to the simplest possible interface (a two-state button or other binary device).

Digital information units 320 are nonvolatile and cannot be altered in normal operation of the data acquisition system 300. The digital information units 320 are writable with a provided device. Each unit 320 is initially written with permanent information pertaining to the element it will describe, such as the identification number or name of the element, serial numbers, size, capacity, etc. The unit 320 can also contain current information pertaining to the element such as date last tested, date last calibrated, test or calibration values, current settings, or set point limits. Writing devices adapted to each circumstance (a sensor or module being periodically calibrated, a piece of equipment being tested, set point values being changed, etc.) are available.

When initiating a test, the data acquisition system 300 will query all connected elements and will self-configure based on the information returned from the digital information units 320. This eliminates the need for the operator 310 to enter information for system components, sensors, equipment being tested, etc., both automating the setup and eliminating transcription and other input errors.

Data transmission means 312, 322 interconnect system subcomponents such as sensors 314, 316, 318, and signal conditioning module 304, which may be either wired or wireless, and are generic in design. Electrical connections are generic and interchangeable wherever possible. The automated configuration function will include the configuration of data transmission means 312, 322, signal conditioning modules 304, system circuits, and other elements to provide the needed electrical connections, sensing circuits, power or excitation circuits, etc. to any connected element based on its identity as conveyed by the digital information unit associated with it.

Digital information units 320 can be physically installed in some elements, such as sensors that would normally have electrical circuits that connect to the system. The units 320 can be attached to equipment as tags or placed in identified locations near the subject elements where they can be scanned or read by a device associated with the system. Units 320 may also be carried by operators 310 as means of user identification or system access.

Embodiments of the present invention utilize digital information ID chip technology to configure the diagnostic system for data acquisition. Each sensor 314, 316, 318 used with the diagnostic system 300 should contain this digital information ID chip 320. Every connector on the signal processing unit 304 will be identical and contain the circuitry necessary for all types of sensors. When the sensor 314, 316, 318 with ID technology is plugged into a connector, the diagnostic system 300 will identify it, configure the appropriate circuitry for the device, and provide an indication that the sensor is connected and providing a good signal. The serial number, calibration information, and sensitivity of the device are automatically recorded and stored in the software database for the test.

Furthermore, the digital information ID chips 320 are writable to store information on the component to be tested. Each valve in the plant can then have a tag affixed to it such that when plugged into the diagnostic system 300 will automatically configure the signal processing unit 304 to acquire data for that particular valve and store the data in the appropriate location 306.

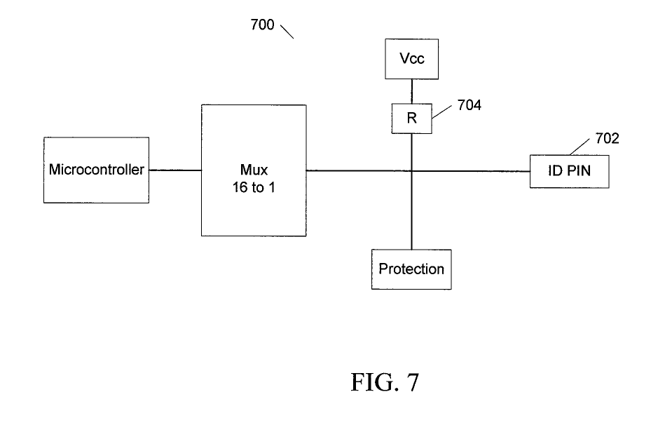

FIG. 7 illustrates an exemplary circuit diagram 700 for a digital information ID unit. The digital information identification (ID) chip 320 should have the following characteristics:
1. ability to transmit information serially from a sensor or valve to the DAU via a single wire;
2. ability to supply power and transmit data on the same wire;
3. since ID chips on the market require a pull up resistor 704 on the ID pin 702 for identification, additional logic should be included to determine if a sensor is connected or not;
4. each sensor input should have a standard scheme of identification;
5. sensor information should be stored locally in flash memory or EEPROM;
6. each sensor should have ample local storage space for identification, configuration and calibration information;
7. each sensor should have an identification code for the module model number, revision level and serial number;
8. interface should be read/write capable;
9. ID pin 702 should be protected against reverse voltage, over voltage and conducted RF noise;
10. bandwidth for the digital interface should be kept low to assure solid communications over long cable lengths and reduced electromagnetic interference (EMI); and
11. digital information ID unit circuitry 700 should support at least three sensors using the same ID pin 702.

Commercially available technology can be used for the auto ID chips. For example, Dallas Semiconductor supplies a 1-wire device such as the DS2432 that combines 1024 bits of EEPROM with a 64-bit secret and 512-bit secure hash algorithm. The DS2432 provides a read memory command that automatically computes and delivers a 160-bit MAC to the 1-wire host (i.e., DAU 30). Each DS2432 has its own factory-lasered 64-bit ROM registration number to provide a unique ID for the system in which it is embedded.

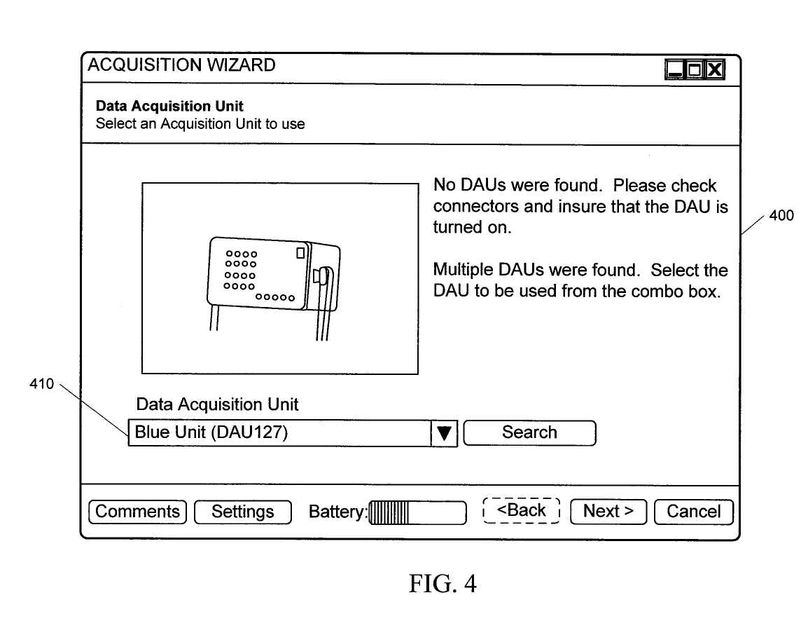

When the diagnostic system 300 is powered up, the software on the data acquisition notebook computer 302 is initiated and will search the Ethernet (wired or wireless) for a signal conditioning unit 304 (referred to as an SCU or DAU). FIG. 4 illustrates an exemplary user interface 400 for the acquisition unit wizard. A combination box 410 is provided for the user 310 to select a signal conditioning unit (i.e., data acquisition unit) 304.

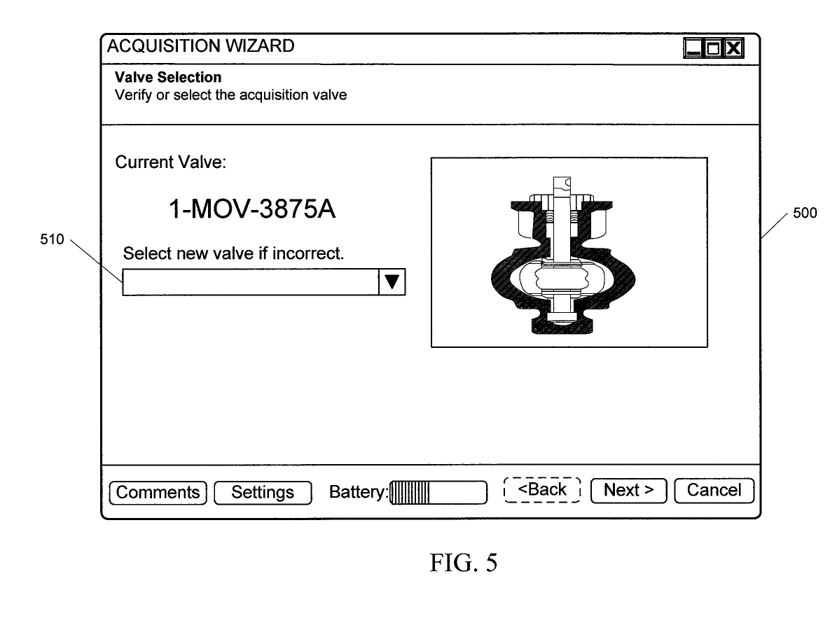

Once the SCU 304 is found, the diagnostic system 300 will poll all connectors plugged into it and identify if a valve tag ID is plugged in or not. If it is, it will identify the valve and associate it with the proper database tag in the software and data storage location 306. FIG. 5 illustrates an exemplary user interface 500 for the acquisition unit wizard. If no valve tag ID is connected, the software of data acquisition unit 302 will prompt the user 310 to select a valve from the database in drop down box 510.

Next, the diagnostic system 300 will read the digital information ID tags 320 of all the sensors/devices plugged into the SCU 304. Based on the sensor IDs, the diagnostic system 300 will automatically configure the SCU 304 hardware 40, 50, 54, 58 to provide the necessary excitation to the device and receive the input signal. The diagnostic system 300 will also store the appropriate sensor information in the record for the test.

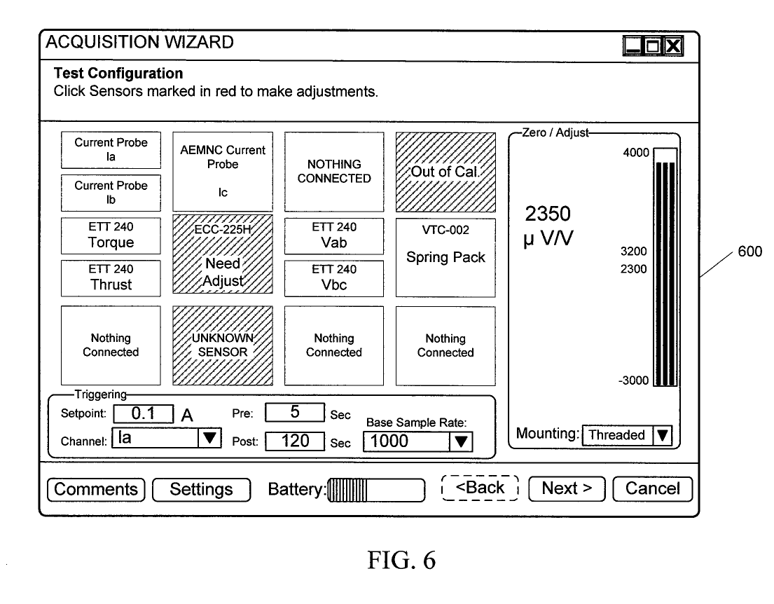

In acquisition mode, the exemplary screen 600 of FIG. 6 will auto-populate information into the PC 302 application software for the connected sensors 314, 316, 318 and valves 330, 340 to include type, serial/model number, and calibration information.

The corresponding structures, materials, acts, and equivalents of all means plus function elements in any claims below are intended to include any structure, material, or acts for performing the function in combination with other claim elements as specifically claimed.

Those skilled in the art will appreciate that many modifications to the exemplary embodiment are possible without departing from the scope of the present invention. In addition, it is possible to use some of the features of the present invention without the corresponding use of the other features. Accordingly, the foregoing description of the exemplary embodiment is provided for the purpose of illustrating the principles of the present invention and not in limitation thereof since the scope of the present invention is defined solely by the appended claims.

What is claimed is:

1. A self-configuring data acquisition system for conducting diagnostic testing of process equipment devices, comprising:
a data acquisition processing unit for controlling diagnostic testing of an equipment device, the equipment device including a digital information unit that stores information uniquely identifying the equipment device and automatically transmits the equipment device identifying information to the data acquisition processing unit;
a signal conditioning unit coupled to the data acquisition unit by a first data transmission means, the signal conditioning unit including a digital information unit that stores information uniquely identifying the signal conditioning unit and automatically transmits the signal conditioning unit identifying information to the data acquisition processing unit;
a sensor coupled with the equipment device under test, wherein the sensor is further coupled to the signal conditioning unit by a second data transmission means and wherein the sensor includes a digital information unit that stores information uniquely identifying the sensor and automatically transmits the sensor identifying information to the data acquisition processing unit; and
a component for automatically configuring the signal conditioning unit, based on the sensor and equipment device identifying information, to excite the equipment device under test and receive a plurality of test data input signals from the equipment device resulting from the excitation.

2. The self-configuring data acquisition system for conducting diagnostic testing of claim 1 further comprising a data storage device coupled to the data acquisition unit for storing the plurality of test data input signals.

3. The self-configuring data acquisition system for conducting diagnostic testing of claim 1 wherein the sensor digital information unit stores a serial number and at least one of a calibration information and a sensitivity of the sensor.

4. The self-configuring data acquisition system for conducting diagnostic testing of claim 3 wherein the information stored in the sensor digital information unit is automatically recorded and stored in the data storage device.

5. The self-configuring data acquisition system for conducting diagnostic testing of claim 1 wherein the sensor digital information unit comprises a one-wire automatic identification device.

6. The self-configuring data acquisition system for conducting diagnostic testing of claim 1 wherein the sensor digital information unit is installed in the sensor.

7. The self-configuring data acquisition system for conducting diagnostic testing of claim 1 wherein the sensor digital information unit is attached to the sensor as a tag.

8. The self-configuring data acquisition system for conducting diagnostic testing of claim 1 wherein the digital information unit associated with the equipment device under test can be read by a scanner and is located in proximity to the equipment device under test.

9. The self-configuring data acquisition system for conducting diagnostic testing of claim 8 wherein the digital information unit associated with the equipment device under test stores at least one of the following data for the equipment device: a date last tested, a date last calibrated, a test value, a calibration value, a current setting, and a setpoint limit.

10. The self-configuring data acquisition system for conducting diagnostic testing of claim 1 wherein the component for automatically configuring the signal conditioning unit comprises a software module installed on the data acquisition unit.

11. The self-configuring data acquisition system for conducting diagnostic testing of claim 1 wherein the first data transmission means comprises either a wired or a wireless communication adapter between the signal conditioning unit and the data acquisition unit.

12. The self-configuring data acquisition system for conducting diagnostic testing of claim 1 wherein the first data transmission means connection comprises an Ethernet 100BaseT adapter.

13. The self-configuring data acquisition system for conducting diagnostic testing of claim 1 wherein the first data transmission means comprises a wireless adapter.

14. The self-configuring data acquisition system for conducting diagnostic testing of claim 1 wherein the second data transmission means comprises either a wired or a wireless communication adapter between the signal conditioning unit and the sensor.

15. The self-configuring data acquisition system for conducting diagnostic testing of claim 1 wherein the second data transmission means connection comprises an Ethernet 100BaseT adapter.

16. The self-configuring data acquisition system for conducting diagnostic testing of claim 1 wherein the second data transmission means comprises a wireless adapter.

17. The self-configuring data acquisition system for conducting diagnostic testing of claim 1 wherein the equipment device under test comprises at least one of a motor-operated valve, an air-operated valve, and a check valve.

18. The self-configuring data acquisition system for conducting diagnostic testing of claim 17 wherein the equipment device is field-tested in an electric power generating plant installation.

19. The self-configuring data acquisition system for conducting diagnostic testing of claim 10 further comprising a software user interface to select a data acquisition unit to control diagnostic testing and, if prompted by the software module, to select the equipment device to test.

20. A method for automatically conducting diagnostic testing of process equipment devices in a self-configuring data acquisition system, comprising:
providing a digital information unit for each of a plurality of components of the data acquisition system including an equipment device under test, a signal conditioning unit, and a sensor associated with the equipment device under test, each digital information unit storing information that uniquely identifies a corresponding component;
automatically transmitting the identifying information stored on each digital information unit to a data acquisition processing unit;
automatically configuring the signal conditioning unit, based on the sensor and equipment device identifying information, to excite the equipment device under test; and
receiving a plurality of test data input signals from the equipment device resulting from the excitation by the signal conditioning unit.

21. The method for automatically conducting diagnostic testing of claim 20 further comprising storing the plurality of test data signals in a data storage device.

22. The method for automatically conducting diagnostic testing of claim 20 further comprising storing a serial number and at least one of a calibration information and sensitivity in the sensor digital information unit.

23. The method for automatically conducting diagnostic testing of claim 22 further comprising automatically recording and storing in the data storage device the information stored in the sensor digital information unit.

24. The method for automatically conducting diagnostic testing of claim 20 further comprising installing a digital information unit in the sensor.

25. The method for automatically conducting diagnostic testing of claim 20 further comprising attaching a digital information unit to the sensor as a tag.

26. The method for automatically conducting diagnostic testing of claim 20 further comprising attaching a digital information unit to the equipment device under test as a tag.

27. The method for automatically conducting diagnostic testing of claim 20 further comprising locating a digital information unit in proximity to the equipment under test and scanning the information stored in the digital information unit and transmitting the scanned information to the signal conditioning unit.

28. The method for automatically conducting diagnostic testing of claim 27 wherein the digital information unit corresponding to the equipment device under test stores at least one of the following data for the equipment device: a date last tested, a date last calibrated, a test value, a calibration value, a current setting, and a set point limit.

29. The method for automatically conducting diagnostic testing of claim 20 further comprising providing a wired connection for communicating information between the signal conditioning unit and the data acquisition processing unit that controls diagnostic testing of the equipment device.

30. The method for automatically conducting diagnostic testing of claim 20 further comprising providing a wireless connection for communicating information between the signal conditioning and the data acquisition unit that controls diagnostic testing of the equipment device.

31. The method for automatically conducting diagnostic testing of claim 20 further comprising providing a wired connection for communicating information between the sensor and the signal conditioning unit.

32. The method for automatically conducting diagnostic testing of claim 20 further comprising providing a wireless connection for communicating information between the sensor and the signal conditioning unit.

33. The method for automatically conducting diagnostic testing of claim 20 wherein the equipment device under test comprises at least one of a motor-operated valve, an air-operated valve, and a check valve.
